(19) United States
(12) Patent Application Publication
(10) Pub. No.: US 2025/0045361 A1
(43) Pub. Date: Feb. 6, 2025

(54) PROTECTION OF DIGITAL ASSETS WITHIN THE BLOCKCHAIN BY APPROVAL REVOCATIONS

(71) Applicant: Fireblocks Ltd., Tel Aviv (IL)

(72) Inventors: Pavel BERENGOLTZ, Ramat Hasharon (IL); Arik GALANSKY, Tel Aviv (IL)

(73) Assignee: Fireblocks Ltd., Tel Aviv (IL)

(21) Appl. No.: 18/362,443

(22) Filed: Jul. 31, 2023

(51) Int. Cl. G06F 21/10

(52) U.S. Cl. CPC G06F 21/1076; G06F 21/1085

(57) ABSTRACT

A method and system for protecting of digital assets within the blockchain by approval revocations. The method comprises detecting an approval of a transaction by a least one user node connected to the approval node over a blockchain network; generating a revoke transaction comprising un-approval of the transaction; monitoring a smart contract associated with the transaction to determine a risk factor; and responsive to the risk factor exceeding a pre-determined risk level threshold, triggering an execution of the revoke transaction.

### TECHNICAL FILED

The present disclosure generally relates to protection of digital assets, and more particularly, to method and system for controlling approvals on smart contracts within a blockchain.

### BACKGROUND

Currently, blockchain is a decentralized and open system without a central regulation of certification authority. Blockchain technology has been adopted for the trading of assets such as non-fungible tokens (NFTs) and cryptocurrency assets.

Each asset-related transaction requires that a smart contract accesses a user's digital wallet to spend the tokens the user intends to invest or swap for other assets. The token allowance is the maximum amount the smart contract has permission to spend from the user's wallet. For example, a user may have $10,000 worth of DAI (a crypto asset that is collateralized by other cryptocurrencies). The user would not want to allow a random small transaction to have access to the entire DAI amount. However, quite often permission being afforded to the smart contract is set to a very large number (“unlimited”) by default.

Obviously, this poses a significant risk for a user having a significant amount of the DAI in his digital wallet. In all situations when currency is exchanged, malicious users may attempt to subvert the process for their own gains. In an ecosystem as complex as blockchain using smart contracts, there will always exist loopholes, backdoors, and weaknesses to exploit. Smart contracts may also refer to tokens, programs, and the like. In particular, swap operations performed with DeFi protocols with unlimited approvals may be highly vulnerable.

The liability can stay on-chain for days, months, and even years and then at some point someone may take over the contract and can clean out the user's wallet (which may have even more funds than when the user approved the transfer). So, the liability can grow over time, especially, as users may not remember all their open approvals.

Since the contracts are often set by default with “unlimited” approval, the users can revoke such approvals manually. However, if the user does not pay attention to the settings, his or her wallet is exposed to a risk of having the content of the wallet stolen. While the existing solutions may only alert users on potential breaches and recommend the user to revoke open approvals, these solutions do not solve a generic problem of delegation/approvals in chains.

Therefore, it would be advantageous to provide a solution that would overcome the deficiencies noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for protecting of digital assets within the blockchain by approval revocations. The method comprises detecting an approval of a transaction by a least one user node connected to the approval node over a blockchain network; generating a revoke transaction comprising un-approval of the transaction; monitoring a smart contract associated with the transaction to determine a risk factor; and responsive to the risk factor exceeding a pre-determined risk level threshold, triggering an execution of the revoke transaction.

Certain embodiments disclosed herein also include a non-transitory computer readable medium having stored thereon instructions for causing a processing circuitry to perform a process, the process comprising: detecting an approval of a transaction by a least one user node connected to the approval node over a blockchain network; generating a revoke transaction comprising un-approval of the transaction; monitoring a smart contract associated with the transaction to determine a risk factor; and responsive to the risk factor exceeding a pre-determined risk level threshold, triggering an execution of the revoke transaction.

Certain embodiments disclosed herein also include a system for protecting of assets by approval revocations. The system comprises a processor of an approval node connected to at least one user node over a blockchain network; a memory on which are stored machine-readable instructions that when executed by the processor, cause the processor to: detect an approval of a transaction by a least one user node connected to the approval node over a blockchain network; generate a revoke transaction comprising un-approval of the transaction; monitor a smart contract associated with the transaction to determine a risk factor; and responsive to the risk factor exceeding a pre-determined risk level threshold, triggering an execution of the revoke transaction.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 illustrates a network diagram of a system for protection of blockchain assets using secure approvals on a blockchain according to some embodiments.

FIG. 2 illustrates an example blockchain architecture configuration, consistent with the present disclosure.

FIG. 3A illustrates a permissioned network, consistent with the present disclosure.

FIG. 3B illustrates another permissioned network, according to an embodiment of the present disclosure.

FIG. 3C illustrates a permissionless the network according to an embodiment of the present disclosure.

FIG. 4A illustrates a flow diagram of a method for protection of blockchain assets using secure approvals according to one embodiment.

FIG. 4B illustrates a further flow diagram of a method for protection of blockchain assets using secure approvals according to one embodiment.

FIG. 5 illustrates a block diagram of a system including a computing device for performing the method for protecting assets by approval revocations.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The present disclosure provides a system, a method and computer-readable medium for protection of assets using secure approvals of smart contracts. In one embodiment of the present disclosure, the system is configured to provide a technology for enabling approval revocations for protection of assets.

In one embodiment, the application for approvals on smart contracts utilizes a decentralized storage (such as a blockchain) that is a distributed storage system, which includes multiple nodes that communicate with each other. The decentralized storage includes an append-only immutable data structure resembling a distributed ledger capable of maintaining records between mutually untrusted parties. The untrusted parties are referred to herein as peers or peer nodes. Each peer maintains a copy of the records and no single peer can modify the records without a consensus being reached among the distributed peers. For example, the peers may execute a consensus protocol to validate blockchain storage and token-related transactions, group the storage transactions into blocks, and build a hash chain over the blocks. This process forms the ledger by ordering the storage transactions, as is necessary, for consistency.

In various embodiments of a system for approvals on smart contracts within a blockchain, a permissioned and/or a permissionless blockchain is disclosed. The system is operable outside of the blockchain, but can access nodes on the blockchain and client devices holding wallets (or other programs) for accessing contracts on the blockchain.

The disclosed system and method for approvals of revocations on smart contracts within a blockchain can utilize a blockchain that operates arbitrary programmable logic tailored to a decentralized storage scheme and referred to as “smart contracts” or “chaincodes.” In some cases, specialized chaincodes may exist for management functions and parameters which are referred to as system chaincode. The disclosed system and method can further utilize to approve or otherwise revoke smart contracts that are trusted distributed applications which leverage tamper-proof properties of the blockchain database and an underlying agreement between nodes, which is referred to as an endorsement or endorsement policy.

Generally, blockchain transactions including smart contracts can be “endorsed” before being committed to the blockchain while transactions, which are not endorsed, are disregarded. An endorsement policy allows chaincode or smart contracts to specify endorsers for a transaction in the form of a set of peer nodes that are necessary for endorsement. When a client device sends the transaction to the peers specified in the endorsement policy, the transaction is executed to validate the transaction. After validation, the transactions enter an ordering phase in which a consensus protocol is used to produce an ordered sequence of endorsed transactions grouped into blocks.

The disclosed embodiments for approvals on smart contracts within a blockchain are performed by a system that communicates with a blockchain network. In an embodiment, the disclosed system (i.e., an approval cloud server or node) is outside of the blockchain network. In some implementation, the system may be a node in the blockchain network. A “node” may perform a logical function in the sense that multiple nodes of different types can run on the same physical server or on different hosts. In a blockchain network, nodes are grouped in trust domains and are associated with logical entities that control them in various ways. Nodes may include different types, such as a client or submitting-client node which submits a transaction-invocation to an endorser (e.g., peer), and broadcasts transaction-proposals to an ordering service (e.g., ordering node). Another type of a node is a peer node which can receive client submitted transactions, commit the transactions and maintain a state and a copy of the ledger of blockchain transactions. Peers can also have the role of an endorser, although it is not a requirement. An ordering-service-node or order is a node running the communication service for all nodes, and which implements a delivery guarantee, such as a broadcast to each of the peer nodes in the system when committing transactions and modifying a world state of the blockchain, which is another name for the initial blockchain transaction which normally includes control and setup information.

Some benefits of the disclosed embodiments described and depicted herein include a method and system for the protection of digital assets in blockchain networks. The disclosed embodiments solve the issues of time and trust by extending features of a database such as immutability, digital signatures and being a single source of truth. The disclosed embodiments provide a solution for making transactions in cryptocurrency and NFTs over a blockchain-based network. The blockchain networks may be homogenous based on the asset type and rules that govern the assets based on the smart contracts.

Blockchain is different from a traditional database in that blockchain is not a central storage, but rather a decentralized, immutable, and secure storage, where nodes must share in changes to records in the storage. Some properties that are inherent in blockchain and which help implement the blockchain include, but are not limited to, an immutable ledger, smart contracts, security, privacy, decentralization, consensus, endorsement, accessibility, and the like, which are further described herein. According to various aspects, the disclosed system and method for approvals on smart contracts within a blockchain involving buying and selling of assets (e.g., tokens) using cryptocurrency in blockchain networks is implemented due to immutable accountability, security, privacy, permitted decentralization, availability of smart contracts, endorsements and accessibility that are inherent and unique to blockchain.

In particular, the disclosed system and method relies on a blockchain ledger data that is immutable. Also, use of the encryption in the blockchain provides security and builds trust. The smart contract manages the state of the asset to complete the life-cycle. The example blockchains are permission decentralized. Thus, each end user may have its own ledger copy to access. Multiple organizations (and peers) may be on-boarded on the blockchain network. The key organizations (e.g., a game token processing server) may serve as one of endorsing peers to validate the smart contract execution results, read-set and write-set. In other words, the blockchain inherent features provide for efficient implementation of the system and method for approvals on smart contracts within a blockchain described herein.

One of the benefits of the disclosed system and method for approvals on smart contracts within a blockchain is that it improves the functionality of a computing system by implementing a method for protection of assets by approval revocations of smart contracts maintained in blockchain-based networks or systems. Through the blockchain network, a computing system can perform functionality for exchanging of crypto-currency assets, smart contracts, NFTs, and the like in blockchain networks by providing access to capabilities such as distributed ledger, peers, encryption technologies, event handling, and so on. Also, the blockchain network enables to create a secure network and make any users or organizations to on-board for participation. As such, the blockchain is not just a database.

The disclosed embodiments provide numerous benefits over a traditional database. For example, through the blockchain the embodiments provide for immutable accountability, security, privacy, permitted decentralization, availability of smart contracts, endorsements and accessibility that are inherent and unique to the blockchain. Meanwhile, a traditional database could not be used to implement the example embodiments because it does not bring all parties on the charitable network, it does not create trusted collaboration and does not provide for an efficient storage and transfer of digital assets such as cryptocurrency, NFTs, and other tokens. The traditional database does not provide for a tamper proof storage and does not provide for preservation of the digital assets being stored. Thus, the proposed method for protection of assets on a blockchain network cannot be implemented in the traditional database.

Accordingly, the example embodiments provide for a specific solution to a problem in the field of NFTs, smart contracts, and crypto-currency assets management including approvals on smart contracts within a blockchain.

According to the exemplary embodiments, a method, system and computer-readable media for monitoring all smart contracts open by the user and revocation of suspicious transactions on such contracts are provided. As the wallet executed on the client device is controlled by the disclosed system, all transactions can be monitored by the disclosed system and signed by the wallet. Thus, the wallet may sign an approval on each contract being opened, and, specifically, for a swap operation. The disclosed embodiments provide the wallet and the control user interface. In one embodiment, the contracts may be monitored to determine a risk factor. If the risk factor exceeds a pre-determined threshold, it indicates a potential security breach. Then, a revoke (i.e., an un-approval) transaction is generated and is triggered for execution by the disclosed system.

In one embodiment, the risk factor may be determined or otherwise computed using an AI module executed or implemented by the disclosed system. In one embodiment, a rule-based engine, executed or implemented by the disclosed system, may be configured to revoke an approval when a certain condition(s) is met. For example, a predefined time elapsed, when the size of the wallet exceeds a predefined threshold amount, when a deposit transaction is detected subsequent to a swap transaction, when two subsequent swap transactions are detected, and, and so on. In an embodiment, the AI module may be configured to compute a risk factor based on the time that the approval is open, the size of the contract, external risk indicators collected from third-party services, by data collected from monitoring the blockchain, and a trading platform. For example, an approval open for a week for a 1 million $ contract may be determined to be riskier than an approval open for 1 hour for a 1000 $.

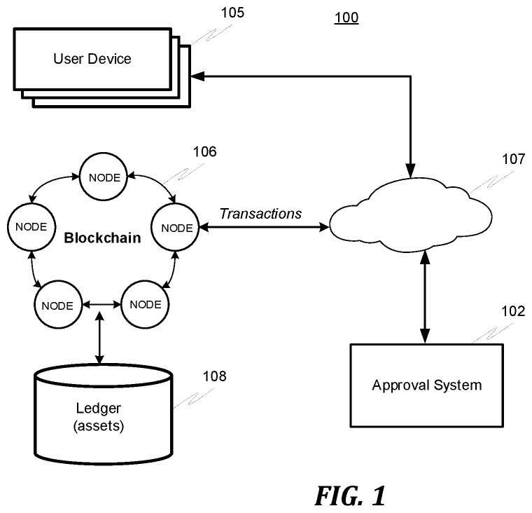

FIG. 1 illustrates a network diagram 100 utilized to describe the various embodiments for protection of assets on a blockchain.

Referring to FIG. 1, the example network 100 includes an approval system 102 connected to user (client) devices 105 and a blockchain network 106 over a network 107 (e.g., the internet). Each of the user devices 105 may host user digital wallets (not shown). A wallet is a program (e.g., an app) executed on a user device 105 that stores private keys and also send, receive, and spend cryptocurrencies approve (sign) or revoke smart contracts, and the like. The approval system 102 may include additional components and that some of the components described herein may be removed and/or modified without departing from a scope of the embodiments disclosed herein. The approval system 102 may receive and send transaction from and to the nodes of the blockchain 106 over the network 107. The approval system 102 may receive and send transactions from and to the user devices 105 over the network 106.

According to the disclosed embodiments, the approval system 102 may be a virtual entity (e.g., a virtual machine executed over a server) deployed in a cloud computing environment. The system 102 may also be deployed on-premises. In both embodiments, the system 102 may be connected off the blockchain network 106.

All transactions signed by these wallets reside in devices 105 may be monitored by the approval system 102. The wallets may sign an approval on each smart contract being opened, and, specifically, for a swap operation. Users may access their wallets via user devices 105 that may have a wallet control user interface connected to the wallet and a blockchain ledger 108. The user devices 105 communicate with the blockchain 106 over the network 107. The user devices 105 may receive and send transaction from and to the nodes of the blockchain 106 over the network 107.

In one embodiment, the contracts may be monitored by the approval system 102 to determine a risk factor. If the risk factor exceeds a pre-determined threshold, the system 102 is configured to indicate a potential security breach. Then, a revoke (i.e., an un-approval) transaction may be triggered for execution by the wallet executed on a device 105. That is, the wallet that opens the contact would run and sign the revoke transaction.

In one embodiment, the risk factor may be determined or otherwise computed using an AI module implemented by the approval system 102. In an embodiment, the AI module is trained to training the AI model to compute the risk factor based on monitoring of the blockchain network. Further, the AI module may be trained to training the AI module to compute the risk factor based on a combination of a duration of an approval being open and a size of the smart contract.

In one embodiment, a rule-based engine (not shown) implemented in the approval system 102 may be configured to revoke an approval when a certain condition(s) is met. For example, a predefined time elapsed, when the size of the wallet exceeds a predefined threshold amount, when a deposit transaction is detected subsequent to a swap transaction, when two subsequent swap transactions are detected, and so on. The system 102 may be configured to compute a risk factor based on the time that the approval is open, the size of the contract, external risk indicators collected from third-party services running on the cloud server, by data collected from monitoring the blockchain network 106 and potentially a trading platform.

In an embodiment, the system 102 includes various circuits, or processors realizing the AI module (not shown) and a rule engine (not shown). The system 102 may also include an application programming interface (API) to communicate with the wallets on user devices 105 and the blockchain network. The API provides a common interface for accessing blockchain logic in user's wallets. The API gateway is a common interface for sending transactions (invoke, queries, etc.) on the blockchain network by connecting to one or more of such a network.

The blockchain network 106 is a blockchain is a type of distributed ledger technology of growing list of blocks (records), that are securely linked together using cryptography. Each block contains a cryptographic hash of the previous block, a timestamp, and transaction data. The blockchain network 106 holds records of smart contracts access through the wallets and controlled by the approval system 102. The blockchain network 106 may include any one of or combination of a private network, a public network, a consortium network, or a hybrid network. The blockchain network 106 may be Ethereum, Polkadot, Steller, Solna, and the like. Further, the blockchain network 106 may be permissioned blockchain network, a permissioned blockchain network, and permissionless blockchain network. The operations of the various networks in respect to the disclosed embodiments are discussed below.

The approval system 102 may be a computing device or a server computer, or the like, and may include a processor, which may be a semiconductor-based microprocessor, a central processing unit (CPU), an application specific integrated circuit (ASIC), a field-programmable gate array (FPGA), and/or another hardware device. Although a single processor may be used, it should be understood that the secure approval system 102 may include multiple processors, multiple cores, or the like, without departing from the scope of the secure approval node 102.

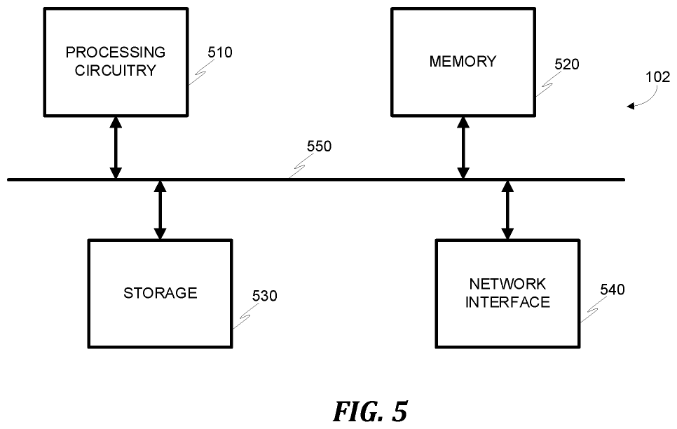

The secure system 102 may also include a non-transitory computer readable medium that may have stored thereon machine-readable instructions executable by the processor. Examples of the machine-readable instructions are further discussed below. Examples of the non-transitory computer readable medium may include an electronic, magnetic, optical, or other physical storage device that contains or stores executable instructions. For example, the non-transitory computer readable medium may be a Random-Access Memory (RAM), an Electrically Erasable Programmable Read-Only Memory (EEPROM), a hard disk, an optical disc, or other type of storage device. A block diagram of the approval system 102 is provided in FIG. 5.

The processor of the system 102 may fetch, decode, and execute the machine-readable instructions to detect an approval of a transaction by the least one user device 105. The processor may fetch, decode, and execute the machine-readable instructions to generate a revoke transaction comprising un-approval of the transaction. The processor may fetch, decode, and execute the machine-readable instructions to monitor a smart contract associated with the transaction to determine a risk factor. The processor may fetch, decode, and execute the machine-readable instructions to, responsive to the risk factor exceeding a pre-determined risk level threshold, trigger an execution of the revoke transaction.

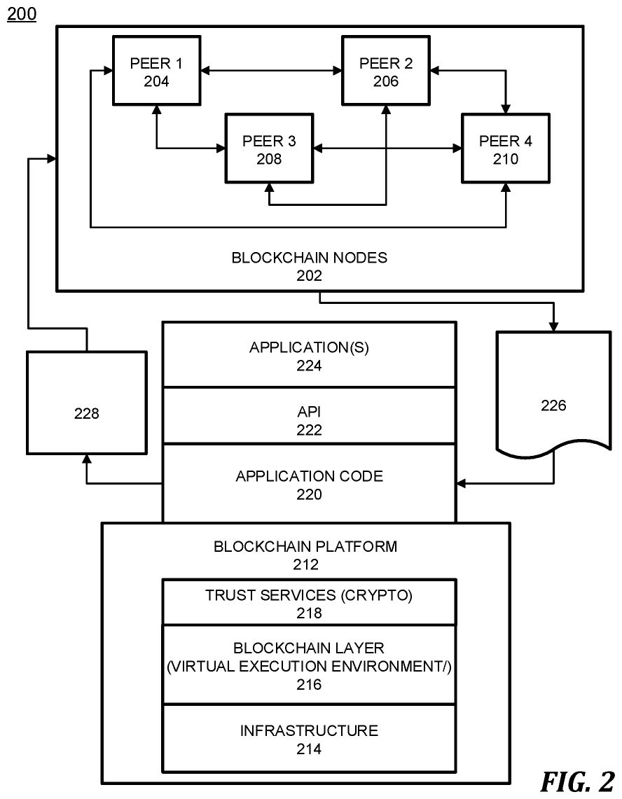

FIG. 2 illustrates a blockchain architecture configuration 200 of the blockchain network 106 according to example embodiments. The blockchain architecture 200 may include certain blockchain elements, for example, a group of blockchain nodes 202. The blockchain nodes 202 may include one or more nodes 204-210 (these four nodes are depicted by example only). These nodes participate in a number of activities, such as blockchain transaction addition and validation process (consensus). One or more of the blockchain nodes 204-210 may endorse transactions based on endorsement policy and may provide an ordering service for all blockchain nodes in the architecture 200.

A blockchain node may initiate a blockchain authentication and seek to write to a blockchain immutable ledger stored in blockchain layer 216, a copy of which may also be stored on the underpinning physical infrastructure 214. The blockchain configuration may include one or more applications 224 which are linked to application programming interfaces (APIs) 222 to access and execute stored program/application code 220 (e.g., chaincodes, smart contracts, etc.) which can be created according to a customized configuration sought by participants and can maintain their own state, control their own assets, and receive external information. This can be deployed as a transaction and installed, via appending to the distributed ledger, on all blockchain nodes 204-210.

The blockchain base or platform 212 may include various layers of blockchain data, services (e.g., cryptographic trust services, virtual execution environment, etc.), and underpinning physical computer infrastructure that may be used to receive and store new transactions and provide access to auditors which are seeking to access data entries. The blockchain layer 216 may expose an interface that provides access to the virtual execution environment necessary to process the program code and engage the physical infrastructure 214. Cryptographic trust services 218 may be used to verify transactions such as asset exchange transactions and keep information private.

The blockchain architecture configuration of FIG. 2 may process and execute program/application code 220 via one or more interfaces exposed, and services provided, by blockchain platform 212. The code 220 may control blockchain assets such cryptocurrency, tokens, smart contracts, or NFTs.

For example, the code 220 can store and transfer data, and may be executed by nodes 204-210 in the form of a smart contract and associated chaincode with conditions or other code elements subject to its execution. As an example, smart contracts may be created to execute reminders, updates, and/or other notifications subject to the changes, updates, and so on. The smart contracts can themselves be used to identify rules associated with authorization and access requirements and usage of the ledger. For example, the information 226 representing the smart contract may be processed by one or more processing entities (e.g., virtual machines) included in the blockchain layer 216. The result 228 may include a smart contract or tokens transferred to a user. The physical infrastructure 214 may be utilized to retrieve any of the data or information described herein and to control approvals on smart contracts within a blockchain.

A smart contract may be created via a high-level application and programming language, and then written to a block in the blockchain. The smart contract may include executable code which is registered, stored, and/or replicated with a blockchain (e.g., distributed network of blockchain peers). A transaction is an execution of the smart contract code which can be performed in response to conditions associated with the smart contract being satisfied. The executing of the smart contract may trigger a trusted modification(s) to a state of a digital blockchain ledger. The modification(s) to the blockchain ledger caused by the smart contract execution may be automatically replicated throughout the distributed network of blockchain peers through one or more consensus protocols.

The smart contract may write data to the blockchain in the format of key-value pairs. Furthermore, the smart contract code can read the values stored in the blockchain and use them in application operations. The smart contract code can write the output of various logic operations into the blockchain. The code may be used to create a temporary data structure in a virtual machine, or other computing platform. Data written to the blockchain can be public and/or can be encrypted and maintained as private. The temporary data that is used/generated by the smart contract is held in memory by the supplied execution environment, then deleted once the data needed for the blockchain is identified.

A chaincode may include the code interpretation of a smart contract, with additional features. As described herein, the chaincode may be program code deployed on a computing network, where it is executed and validated by chain validators together during a consensus process. The chaincode receives a hash and retrieves from the blockchain a hash associated with the data template created by use of a previously stored feature extractor. If the hashes of the hash identifier and the hash created from the stored identifier template data match, then the chaincode sends an authorization key to the requested service. The chaincode may write to the blockchain data associated with the cryptographic details.

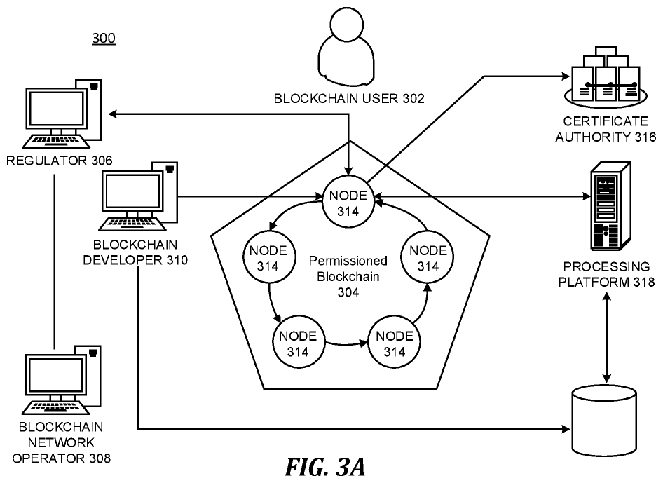

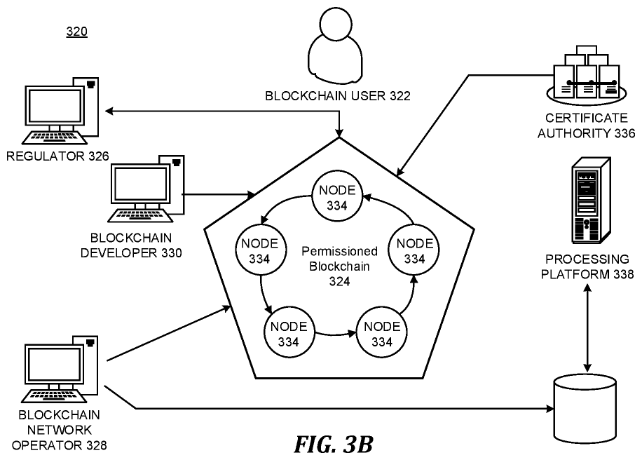

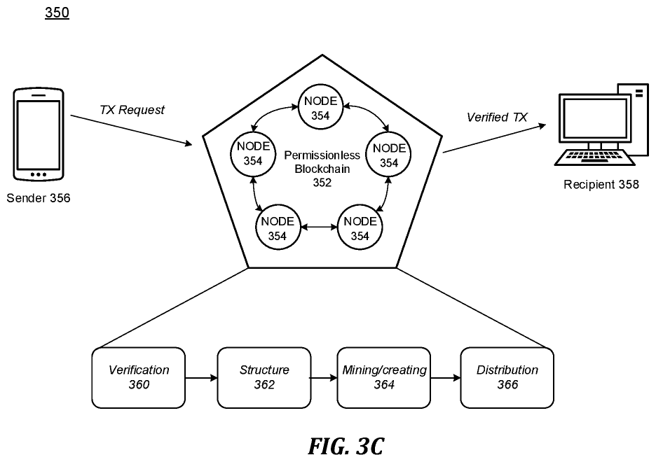

FIG. 3A illustrates an example of a permissioned blockchain network 300, which features a distributed, decentralized peer-to-peer architecture. In this example, a blockchain user 302 may initiate a transaction to the permissioned blockchain 304. In this example, the transaction can be a deploy, invoke, or query, and may be issued through a client-side application leveraging an SDK, directly through an API, and so on. Networks may provide access to a regulator 306, such as an auditor. A blockchain network operator 308 manages member permissions, such as enrolling the regulator 306 as an “auditor” and the blockchain user 302 as a “client.” An auditor could be restricted only to querying the ledger whereas a client could be authorized to deploy, invoke, and query certain types of chaincode. As discussed above, approvals and invocation on smart contracts within a blockchain may be made based on monitoring of the blockchain by the approval system 102.

A blockchain developer 310 can write chaincode and client-side applications. The blockchain developer 310 can deploy chaincode directly to the network through an interface. To include credentials from a traditional data source 312 in chaincode, the developer 310 could use an out-of-band connection to access the data. In this example, the blockchain user 302 connects to the permissioned blockchain 304 through a peer node 314. Before proceeding with any transactions, the peer node 314 retrieves the user's enrollment and transaction certificates from a certificate authority 316, which manages user roles and permissions. In some cases, blockchain users must possess these digital certificates in order to transact on the permissioned blockchain 304. Meanwhile, a user attempting to utilize chaincode may be required to verify their credentials on the traditional data source 312. To confirm the user's authorization, chaincode can use an out-of-band connection to this data through a traditional processing platform 318.

FIG. 3B illustrates another example of a permissioned blockchain network 320, which features a distributed, decentralized peer-to-peer architecture that may be used for approvals on smart contracts within a blockchain. In this example, a blockchain user 322 may submit a transaction to the permissioned blockchain 324. In this example, the transaction can be deployed, invoked, or queried, and may be issued through a client-side application leveraging an SDK, directly through an API, and so on. Networks may provide access to a regulator 326, such as an auditor. A blockchain network operator 328 manages member permissions, such as enrolling the regulator 326 as an “auditor” and the blockchain user 322 as a “client.” An auditor may be restricted only to querying the ledger whereas a client could be authorized to deploy, invoke, and query certain types of chaincode.

A blockchain developer 330 writes chaincode and client-side applications. The blockchain developer 330 can deploy chaincode directly to the network through an interface. To include credentials from a traditional data source 332 in chaincode, the developer 330 could use an out-of-band connection to access the data. In this example, the blockchain user 322 connects to the network through a peer node 334. Before proceeding with any transactions, the peer node 334 retrieves the user's enrollment and transaction certificates from the certificate authority 336. In some cases, blockchain users must possess these digital certificates in order to transact on the permissioned blockchain 324. Meanwhile, a user attempting to utilize chaincode may be required to verify their credentials on the traditional data source 332. To confirm the user's authorization, chaincode can use an out-of-band connection to this data through a traditional processing platform 338.

In some embodiments, the blockchain being monitored by the system 102 may be a permissionless blockchain. In contrast with permissioned blockchains which require permission to join, anyone can join a permissionless blockchain. For example, to join a permissionless blockchain a user may create a personal address and begin interacting with the network, by submitting transactions, and hence adding entries to the ledger. Additionally, all parties have the choice of running a node on the system and employing the mining (or creation) protocols to help verify transactions. In one embodiment, one node may be used to control approvals on smart contracts within a blockchain.

FIG. 3C illustrates a process 350 of a transaction being processed by a permissionless blockchain 352 including a plurality of nodes 354. A sender 356 desires to send payment or some other form of value (e.g., NFTs or any other assets that can be encapsulated in a digital record) to a recipient 358 via the permissionless blockchain 352.

In one embodiment, each of the sender device 356 and the recipient device 358 may have digital wallets (associated with the blockchain 352) that provide user interface controls and a display of transaction parameters. In response, the transaction is broadcast throughout the blockchain 352 to the nodes 354. Depending on the blockchain's 352 network parameters the nodes verify 360 the transaction based on rules (which may be pre-defined or dynamically allocated) established by the permissionless blockchain 352 creators. For example, this may include verifying the identities of the parties involved (e.g., NFT owner, document owner, etc.). The transaction may be verified immediately, or it may be placed in a queue with other transactions and the nodes 354 determine if the transactions are valid based on a set of network rules.

In structure 362, valid transactions are formed into a block and sealed with a lock (hash). This process may be performed by mining nodes among the nodes 354. Mining nodes may utilize additional software specifically for mining and creating blocks for the permissionless blockchain 352. Each block may be identified by a hash (e.g., 256-bit number, etc.) created using an algorithm agreed upon by the network. Each block may include a header, a pointer or reference to a hash of a previous block's header in the chain, and a group of valid transactions. The reference to the previous block's hash is associated with the creation of the secure independent chain of blocks.

Before blocks can be added to the blockchain, the blocks must be validated. Validation for the permissionless blockchain 352 may include a proof-of-work (PoW) which is a solution to a puzzle derived from the block's header. Although not shown in the example of FIG. 3C, another process for validating a block is proof-of-stake. Unlike the proof-of-work, where the algorithm rewards miners who solve mathematical problems, with the proof of stake, a creator of a new block is chosen in a deterministic way, depending on its wealth, also defined as “stake.” Then, a similar proof is performed by the selected/chosen node. In one embodiment, one or more nodes may be used to control approvals on smart contracts within a blockchain.

With mining or creating 364, nodes try to solve the block by making incremental changes to one variable until the solution satisfies a network-wide target. This creates the PoW thereby ensuring correct answers. In other words, a potential solution requires proving that computing resources were drained in solving the problem. In some types of permissionless blockchains, miners may be rewarded with value (e.g., coins, etc.) for correctly mining a block.

Here, the PoW process, alongside the chaining of blocks, makes modifications of the blockchain extremely difficult, as an attacker must modify all subsequent blocks in order for the modifications of one block to be accepted. Furthermore, as new blocks are mined, the difficulty of modifying blocks increases, and the number of subsequent blocks increases. With distribution 366, the successfully validated block is distributed through the permissionless blockchain 352 and all nodes 354 add the block to a majority chain which is the permissionless blockchain's 352 auditable ledger. Furthermore, the value in the transaction submitted by the sender 356 is deposited or otherwise transferred to the digital wallet of the recipient device 358.

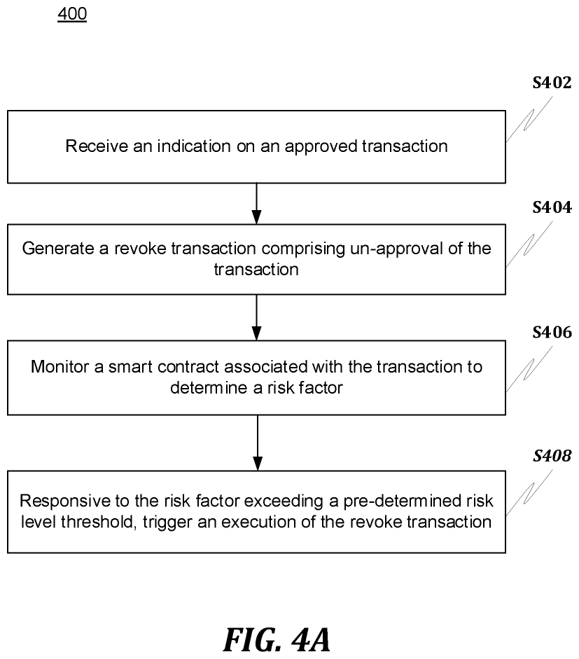

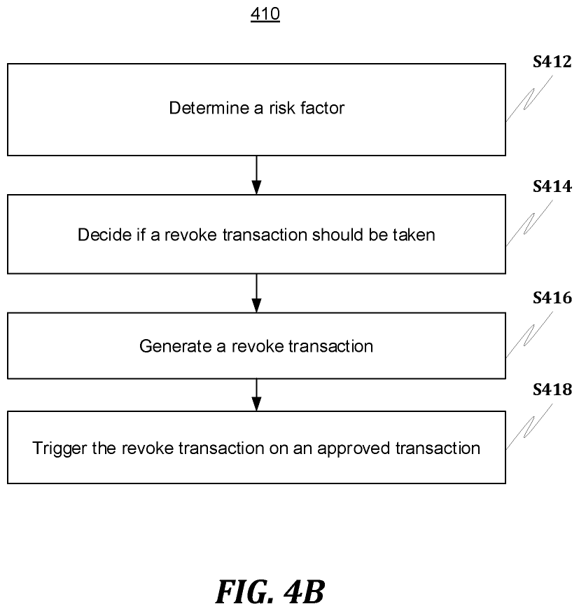

FIG. 4A illustrates an example flow diagram 400 of a method of protecting assets on a blockchain by approval revocations, according to the disclosed embodiments. The method may be executed by the approval system 102 (see FIG. 1). It should be understood that the method 400 depicted in FIG. 4A may include additional operations and that some of the operations described therein may be removed and/or modified without departing from the scope of the method 400. The description of the method 400 may be performed by processing circuitry of the approval system 102 may execute some or all of the operations included in the method 400.

With reference to FIG. 4A, at S402, an indication on approval of a transaction by the least one user node is received. The indication may be received from the blockchain network or from a user device running a user wallet. In another embedment, the blockchain network and/or the wallet are monitored to determine if an approval transaction is detected.

At S404, in response to an approval transaction, a revoke transaction including un-approval of the transaction (hereinafter a revoke transaction) may be generated. It should be noted that the revoke transaction is generated and not activated at S404.

At S406, smart contract associated with the approval transaction is monitored to determine a risk factor. In one embodiment, the risk factor may be determined or otherwise computed using an AI module. Such AI module may be configured to compute a risk factor based on the time that the approval is open, the size of the contract, external risk indicators collected from third-party services, by data collected from monitoring the blockchain, and a trading platform. For example, an approval open for a week for a 1 million $ contract may be determined to be riskier than an approval open for 1 hour for a 1000 $. Various embodiments to compute or otherwise determine the risk factor are discussed above.

At S408, responsive to the risk factor exceeding a pre-determined risk level threshold, an execution of the revoke transaction is triggered. In an embodiment, S408, may include generating a revoke transaction and execution of the same time. It should be emphasized that the revoke transaction includes revoke of an approval set with the contract.

FIG. 4B illustrates a further flow diagram 410 of a method of protection of assets on a blockchain according to the disclosed embodiments. The method may be executed by the approval system 102 (see FIG. 1). It should be understood that the method 410 depicted in FIG. 4B may include additional operations and that some of the operations described therein may be removed and/or modified without departing from the scope of the method 410.

At S412, the risk factor is determined. In this embodiment, the risk factor may be determined or updated based on computational performed by a rule-engine. For example, a predefined time elapsed, when the size of the wallet exceeds a predefined threshold amount, when a deposit transaction is detected subsequent to a swap transaction, when two subsequent swap transactions are detected, and, and so on.

At S414, based on at least one rule determined the rule-engine a decision is made if a revoke transaction should be made. For example, the decision may be based on a deposit and swap transactions. That is, the transaction should be revoked if a deposit transaction is subsequent to a swap transaction. It should be noted that the rule-engine may also consider a risk factor determined by an AI module when deciding whether or not revoke a transaction.

At S416, a revoke transaction is generated responsive to detection of a deposit transaction subsequent to a swap transaction. At S418, the revoke transaction is issued responsive to detection of two transactions subsequent to two swap transactions. It should be noted that revoke transaction revokes an approval of a transaction.

FIG. 5 illustrates a block diagram of the approval system 102 that can be utilized to perform the processes described with reference to FIGS. 4A and 4B.

The approval system 102 includes a processing circuitry 510 coupled to a memory 520, a storage 530, and a network interface 540 connected via a bus 550.

The processing circuitry 510 and the AI module and rule-engine discussed above may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 520 may be volatile (e.g., random access memory, etc.), non-volatile (e.g., read only memory, flash memory, etc.), or a combination thereof.

In one configuration, software for implementing one or more embodiments disclosed herein may be stored in the storage 530. In another configuration, the memory 520 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 510, cause the processing circuitry 510 to perform the various processes described herein. That is, the processing circuitry 510 may fetch, decode, and execute the machine-readable instructions to detect an approval of a transaction by the least one user device 105. The processing circuitry 510 may fetch, decode, and execute the machine-readable instructions to generate a revoke transaction comprising un-approval of the transaction. The processor may fetch, decode, and execute the machine-readable instructions to monitor a smart contract associated with the transaction to determine a risk factor. The processor may fetch, decode, and execute the machine-readable instructions to, responsive to the risk factor exceeding a pre-determined risk level threshold, trigger an execution of the revoke transaction.

The storage 530 may be magnetic storage, optical storage, and the like, and may be realized, for example, as flash memory or other memory technology, or any other medium which can be used to store the desired information. The network interface 540 allows the device 500 to communicate with a network, such as the blockchain network.

It should be understood that the embodiments described herein are not limited to the specific architecture illustrated in FIG. 5, and other architectures may be equally used without departing from the scope of the disclosed embodiments.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for protecting of digital assets within the blockchain by approval revocations, comprising:
detecting an approval of a transaction by a least one user node connected to the approval node over a blockchain network;
generating a revoke transaction comprising un-approval of the transaction;
monitoring a smart contract associated with the transaction to determine a risk factor; and
responsive to the risk factor exceeding a pre-determined risk level threshold, triggering an execution of the revoke transaction.

2. The method of claim 1, further comprising:
determining the risk factor based on any one of: elapsed pre-defined time; and wallet's size exceeded a pre-defined threshold.

3. The method of claim 1, further comprising:
revoking the transaction by a rule engine.

4. The method of claim 3, further comprising:
revoking, by the rule engine, the transaction responsive to detection of a deposit transaction subsequent to a swap transaction.

5. The method of claim 3, further comprising:
revoking, by the rule engine, the transaction responsive to detection of two transactions subsequent to two swap transactions.

6. The method of claim 1, further comprising:
computing the risk factor using an AI model trained to compute the risk factor.

7. The method of claim 6, further comprising:
training the AI model to compute the risk factor based on monitoring of the blockchain network.

8. The method of claim 8, further comprising:
training the AI module to compute the risk factor based on a combination of a duration of an approval being open and a size of the smart contract.

9. A non-transitory computer readable medium having stored thereon instructions for causing a processing circuitry to perform a process, the process comprising:
detecting an approval of a transaction by a least one user node connected to the approval node over a blockchain network;
generating a revoke transaction comprising un-approval of the transaction;
monitoring a smart contract associated with the transaction to determine a risk factor; and
responsive to the risk factor exceeding a pre-determined risk level threshold, triggering an execution of the revoke transaction.

10. A system for protecting of assets by approval revocations, comprising:
a processor of an approval node connected to at least one user node over a blockchain network;
a memory on which are stored machine-readable instructions that when executed by the processor, cause the processor to:
detect an approval of a transaction by a least one user node connected to the approval node over a blockchain network;
generate a revoke transaction comprising un-approval of the transaction;
monitor a smart contract associated with the transaction to determine a risk factor; and
responsive to the risk factor exceeding a pre-determined risk level threshold, triggering an execution of the revoke transaction.

11. The system of claim 10, wherein the system is further configured to:
determine the risk factor based on any one of: elapsed pre-defined time; and wallet's size exceeded a pre-defined threshold.

12. The system of claim 10, wherein the system is further configured to:
revoke the transaction by a rule engine.

13. The system of claim 12, wherein the rule engine is configured to:
revoke the transaction responsive to detection of a deposit transaction subsequent to a swap transaction.

14. The system of claim 12, wherein the rule engine is further configured to:
revoke transaction responsive to detection of two transactions subsequent to two swap transactions.

15. The system of claim 1, wherein the system further comprises an AI module configured to compute the risk factor.

16. The system of claim 15, wherein the system is further configured to:
train the AI module to compute the risk factor based on monitoring of the blockchain network.

17. The system of claim 15, wherein the system is further configured to:
train the AI module to compute the risk factor based on a combination of a duration of an approval being open and a size of the smart contract.
